(19) United States
(12) Patent Application Publication
(10) Pub. No.: US 2015/0089666 A1
(43) Pub. Date: Mar. 26, 2015

(54) APPARATUS AND METHOD FOR PROTECTING PRIVACY IN TERMINAL

(71) Applicant: Pantech Co., Ltd., Seoul (KR)

(72) Inventors: Chang Dae LEE, Seoul (KR); Kyung Hoon Kim, Seoul (KR)

(21) Appl. No.: 14/493,934

(22) Filed: Sep. 23, 2014

(30) Foreign Application Priority Data
Sep. 23, 2013 (KR) 10-2013-0112300

(51) Int. Cl. G06F 21/60; H04W 12/08

(52) U.S. Cl. CPC G06F 21/604; H04W 12/08
USPC 726/27

(57) ABSTRACT

Provided is an apparatus and method for protecting privacy in a terminal that may verify or determine whether a lock screen unlock input corresponds to an unlock input to enter a secret mode or an unlock input to enter a standard mode in response to sensing the lock screen unlock input, set a secret database (DB) to be inaccessible in response to a verification or determination that the lock screen unlock input corresponds to an unlock input to enter the standard mode, and set the secret DB to be accessible in response to a verification or determination that the lock screen unlock input corresponds to an unlock input to enter the secret mode.

### CROSS-REFERENCE TO RELATED APPLICATION

This application claims priority from and the benefit of Korean Patent Application No. 10-2013-0112300, filed on Sep. 23, 2013, which is hereby incorporated by reference for all purposes as if fully set forth herein.

### BACKGROUND

1. Field

Exemplary embodiments of the present invention relate to technology that protects privacy in a terminal, and more particularly, to an apparatus and method for protecting privacy in a terminal that may enable a secret contact list set by a user and relevant information to be accessible in a predetermined mode.

2. Discussion of the Background

With the rapid development of portable terminals, a cellular phone capable of a wireless voice call and data exchange has become a necessity of life. An early version of a portable terminal was regarded as being simply portable and capable of a wireless call. However, with the development of relevant technology and the introduction of wireless Internet, a range of use of a portable terminal has been broadened from a simple phone call or schedule management to image capturing using an embedded digital camera, satellite broadcast viewing, games, web surfing through wireless Internet, a connection service with a wireless device using Bluetooth, music listening, and an electronic mail service.

Various application programs selected by a user may be installed on the portable terminal in addition to application programs provided by manufacturers.

Since functions other than a calling function have been added to the portable terminal, contents of the portable terminal may be provided to users without security settings and private information and secured information may be viewed by unauthorized users. Thus, privacy of the authorized user may be invaded by unauthorized users.

### SUMMARY

Exemplary embodiments of the present invention provide a terminal and method for providing a secret mode.

Additional features of the invention will be set forth in the description which follows, and in part will be apparent from the description, or may be learned by practice of the invention.

Exemplary embodiments of the present invention provide a method for providing a secret mode of a mobile terminal, the method including: determining whether an input corresponds to an input to enter a secret mode; and controlling, by a controller of the mobile terminal, a secret item to be output in the secret mode, the secret item being restricted in a non-secret mode.

Exemplary embodiments of the present invention provide a mobile terminal to provide a secret mode, including: a processor to determine whether an input corresponds to an input to enter a secret mode, and control a secret item to be output in the secret mode, the secret item being restricted in a non-secret mode.

Exemplary embodiments of the present invention provide a mobile terminal to provide a secret mode, including: an interface to receive a user input to select an item; a display to display a plurality of items; a processor to determine a selected item as a secret item, to obtain a right from an application associated with the secret item, and to retrieve information associated with the secret item from the application in a secret mode. The processor, in a non-secret mode, executes the application and modifies a display screen of the executed application to restrict the information associated with the secret item.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a configuration to protect privacy in a terminal according to an exemplary embodiment of the present invention.

FIG. 2 is a flowchart illustrating a method of protecting privacy through a user authentication in a terminal according to an exemplary embodiment of the present invention.

FIG. 3 is a flowchart illustrating a method of protecting privacy through an unlock input in a terminal according to an exemplary embodiment of the present invention.

FIG. 4 is a flowchart illustrating an example of hiding secret information in a terminal according to an exemplary embodiment of the present invention.

FIG. 5 is a flowchart illustrating another example of hiding secret information in a terminal according to an exemplary embodiment of the present invention.

FIG. 6 is a flowchart illustrating a method of providing secret information through a double lock function in a terminal according to an exemplary embodiment of the present invention.

FIG. 7 is a flowchart illustrating a method of moving a contact included in a standard contact list to a secret contact list in a terminal according to an exemplary embodiment of the present invention.

FIG. 8 is a flowchart illustrating a method of processing a notification event in a terminal according to an exemplary embodiment of the present invention.

FIG. 9 is a flowchart illustrating a method of assigning an attribute in a terminal according to an exemplary embodiment of the present invention.

FIG. 10 illustrates an example of outputting a secret contact list based on double lock settings in a terminal according to an exemplary embodiment of the present invention.

FIG. 11 illustrates an example of a menu output in a secret mode and a menu output in a standard mode in a terminal according to an exemplary embodiment of the present invention.

FIG. 12 illustrates an example of notification settings in a terminal according to an exemplary embodiment of the present invention.

FIG. 13A and FIG. 13B are diagrams illustrating examples of icon setting for secret mode according to exemplary embodiments of the present invention.

FIG. 14 is a diagram illustrating an example of accessing information associated with a secret item in an application according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present.

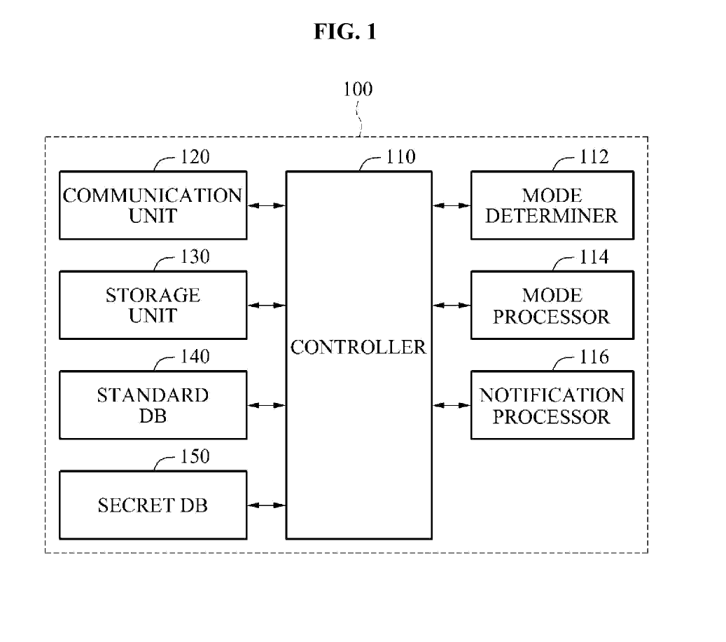

Hereinafter, an apparatus and method for protecting privacy in a terminal, for example a portable terminal, according to an exemplary embodiment of the present invention will be described in detail with reference to FIG. 1 through FIG. 12.

FIG. 1 is a block diagram illustrating a configuration to protect privacy in a terminal 100 according to an exemplary embodiment of the present invention. An apparatus for protecting privacy may be included in a terminal or may be a part of the terminal and thus, the terms “apparatus for protecting privacy” and “terminal” may be used interchangeably.

Referring to FIG. 1, the terminal 100 may include a controller 110, a mode determiner 112, a mode processor 114, a notification processor 116, a communication unit 120, a storage unit 130, a standard database (DB) 140, and a secret DB 150. The terminal 100 may include one or more hardware processors and processors described herein, e.g., the mode processor 114, a notification processor 116, and one or more determiners, e.g., the mode determiner 112, may be implemented in a single hardware processor or a plurality of hardware processors.

The communication unit 120 may refer to a communication interface device including a receiver and a transmitter. The communication unit 120 may transmit and receive signals of data to be input and output through one or more antennas (not shown). For example, in a case of transmission, the communication unit 120 may perform channel coding, spreading, and radio frequency (RF) processing on data to be transmitted, and transmit the processed data. In a case of reception, the communication unit 120 may decode data by converting a received RF signal to a baseband signal and performing de-spreading and channel decoding on the baseband signal.

The storage unit 130 may store an application program and an operating system to control an overall operation of the terminal 100. The storage unit 130 may include the standard DB 140 and the secret DB 150. The standard DB 140 or the secret DB 150 may be implemented in a memory separate from the terminal 100, which may be connected to the storage unit 130 via the controller 110.

The standard DB 140 may include a standard contact list storing contacts, for example, standard phone numbers not necessary or required to be hidden, and information relevant to the standard contact list, which is not regarded as secret information of an authorized user. The information relevant to the standard contact list may include data transmitted to and received from a target included in the standard contact list, and information related to the target included in the standard contact list. The information related to the target included in the standard contact list may include a short message service (SMS) message, a call log, an image file, a video, etc.

The secret DB 150 may include a secret contact list storing hidden contacts, for example, phone numbers selected by a user to be hidden, and information relevant to the secret contact list. The information relevant to the secret contact list may include data transmitted to and received from a target included in the secret contact list, information related to the target included in the secret contact list, and information derived from the secret DB 150. The information related to the target included in the secret contact list may include an SMS message, a call log, an image file, and a video. The information relevant to the standard contacts and the secret contacts may, in general, be of the same types; however, the information relevant to the secret contacts is required or desired to be kept private.

Although two DBs are used herein to distinguish between a standard contact list and a secret contact list, the terminal 100 may be implemented by adding, to a single DB, an attribute value used to determine whether information corresponds to secret information.

However, an implementation using two DBs may easily block access to a secret DB and thus, be more effective in managing secured information.

The mode determiner 112 may determine a mode of the terminal 100 in response to a user authentication when the user authentication is input. For example, when the user authentication corresponds to a lock screen unlock input, the mode determiner 112 may determine the mode of the terminal 100 in response to the lock screen unlock input.

The mode determiner 112 may determine whether the user authentication corresponds to a user authentication to enter a secret mode or a user authentication to enter a standard mode.

The mode determiner 112 may also employ a method using two accounts as a user authentication method, in addition to the unlock input method.

More specifically, the mode determiner 112 may use a first account with which the standard DB 140 is accessible, and a second account with which both the standard DB 140 and the secret DB 150 are accessible. If the user logs in with the first account, the mode determiner 112 may determine that the mode of the terminal 100 corresponds to the standard mode. If the user logs in with the second account, the mode determiner 112 may determine that the mode of the terminal 100 corresponds to the secret mode.

Although the terminal 100 enters the standard mode, the terminal 100 may switch to the secret mode in response to an input of a preset user authentication to switch to the secret mode.

The mode processor 114 may set a contact list and information relevant to the contact list corresponding to each mode to be accessible based on a result of the determination performed by the mode determiner 112.

If the mode determiner 112 determines that the terminal 100 enters the standard mode, the mode processor 114 may set a secret contact list and information relevant to the secret contact list registered in the secret DB 150 to be inaccessible by setting the secret DB 150 to be inaccessible.

If the terminal 100 enters the standard mode, the mode processor 114 may control the secret contact list and the information relevant to the secret contact list not to be displayed on a screen of the terminal 100 for all applications installed on the terminal 100. In this example, the mode processor 114 may control an application by obtaining an authority over the application.

If the terminal 100 enters the standard mode, the mode processor 114 may transmit a request message to an application installed on the terminal 100 to request that the secret contact list and the information relevant to the secret contact list not be displayed on the screen of the terminal 100, and request that the secret contact list and the information relevant to the secret contact list be deleted or not be displayed in the application.

The mode processor 114 may provide a standard contact list and information relevant to the standard contact list registered in the standard DB 140 at a request of the user in the standard mode.

The mode processor 114 may not display any information regarding whether a secret mode exists in the standard mode.

If the mode determiner 112 determines that the terminal 100 enters the secret mode, the mode processor 114 may set the secret contact list and the information relevant to the secret contact list to be accessible by setting the secret DB 150 to be accessible.

If the terminal 100 enters the secret mode, the mode processor 114 may provide, at a request of the user, the standard contact list and the information relevant to the standard contact list registered in the standard DB 140, and the secret contact list and the information relevant to the secret contact list together or separately.

The mode processor 114 may require one or more authentications before providing access to information in the secret DB 150. For example, when the mode determiner 112 determines that a user authentication corresponds to a user authentication to enter the secret mode, the mode processor 114 may display that the secret DB 150 is accessible. In response to sensing a secondary user authentication requesting access to the secret DB 150, the mode processor 114 may provide the secret contact list and the information relevant to the secret contact list.

The secondary user authentication may be identical to or different from the user authentication to enter the secret mode. The user authentication may be performed using one or more methods of authenticating a user, for example, pattern recognition, face recognition, fingerprint recognition, and a password.

The mode processor 114 may store a target contact in the secret contact list, store information relevant to the target contact in the secret DB 150, and delete the target contact and the information relevant to the target contact from the standard DB 140 in response to a reception of a request for movement of at least one contact included in the standard contact list registered in the standard DB 140 to the secret contact list.

The mode processor 114 may delete the target contact from the secret contact list and delete the relevant information together in response to a reception of a request for deletion of a target stored in the secret contact list in the secret mode. In this example, whether the information relevant to the target contact is to be deleted may be indicated to the user and the user may select the deletion. The information relevant to the target contact may be deleted based on a selection of the user. If the user determines not to delete the relevant information, the information relevant to the target contact may be moved to the standard DB 140, and managed as information relevant to a target unregistered in a contact list.

The mode processor 114 may store the target contact in the standard contact list, store the information relevant to the target contact in the standard DB 140, and delete the target contact and the information relevant to the target contact from the secret DB 150 in response to a reception of a request for movement of the target stored in the secret contact list to a standard contact list in the secret mode.

If a target to which a predetermined attribute is to be assigned is selected, the mode processor 114 may detect relevant information related to the target stored in the terminal 100, and assign the attribute to the target and the detected relevant information. The assigned attribute may include one of deleting, hiding, and locking. The detected relevant information may include one of an address, a call log, an image file, and a video. The mode processor 114 may assign the attribute to the target in both the standard mode and the secret mode, or only in the secret mode.

In response to sensing a notification event related to the target stored in the secret contact list, the notification processor 116 may verify or determine a current mode of the terminal 100. If the current mode of the terminal 100 does not correspond to the secret mode, the notification processor 116 may display the notification event using a display method preset by the user such that the privacy information of the authorized user is protected.

The notification event may include at least one of an incoming call, an incoming message, a missed call, and an application message.

The display method preset by the user may include at least one of a method of emitting light in a preset color or a preset pattern using a light emitting diode (LED) of the terminal 100, a method of outputting an icon corresponding to the notification event, the icon preset by the user, a method of filtering out a corresponding notification event not to be displayed for the user, and a method of displaying a notification event emulating a reception of a call or a message from an unregistered target.

The notification processor 116 may not display an occurrence count with respect to an identical type of notification events when displaying a notification event using the display method preset by the user.

If the notification event displayed using the preset display method is selected by a user in a mode other than the secret mode, the notification processor 116 may delete the notification event displayed using the preset display method.

If the notification event corresponds to an incoming call from a contact list stored in the secret contact list, the notification processor 116 may block an incoming call or display the notification event using the display method preset by the user based on user settings.

If the current mode of the terminal 100 corresponds to the secret mode, the notification processor 116 may output the notification event without modification.

The controller 110 may control an overall operation of the terminal 100. The controller 110 may perform functions of the mode determiner 112, the mode processor 114, and the notification processor 116. In FIG. 1, the controller 110, the mode determiner 112, the mode processor 114, and the notification processor 116 are separately illustrated to individually describe functions of the controller 110, the mode determiner 112, the mode processor 114, and the notification processor 116. Accordingly, the controller 110 may include at least one processor configured to perform all of the functions of the mode determiner 112, the mode processor 114, and the notification processor 116, or to perform only a portion of the functions of the mode determiner 112, the mode processor 114, and the notification processor 116.

Hereinafter, a method of protecting privacy in a terminal 100 configured as described above will be described with reference to the drawings.

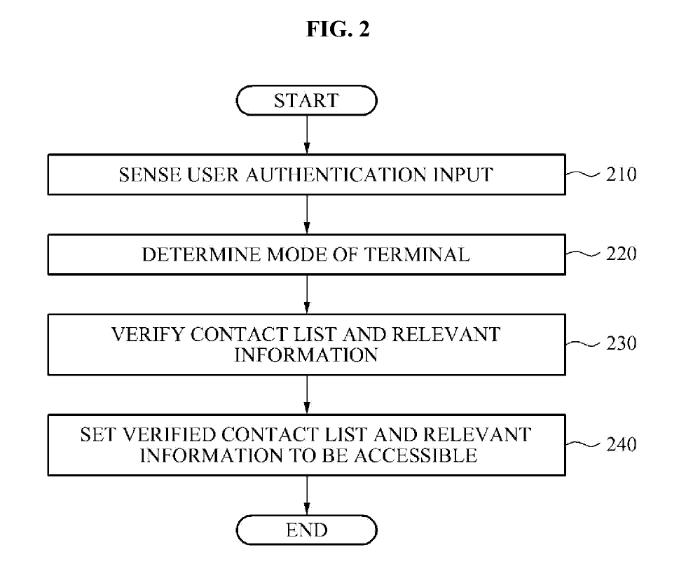

FIG. 2 is a flowchart illustrating a method of protecting privacy through a user authentication in the terminal 100 of FIG. 1 according to an exemplary embodiment of the present invention.

Referring to FIG. 2, in operation 210, the terminal 100 may sense an input of a user authentication. The user authentication may be input through unlocking of a lock screen, or through a preset account.

If the input of the user authentication is sensed in operation 210, a mode of the terminal 100 may be determined in response to the user authentication, in operation 220. The mode of the terminal 100 may include a secret mode for privacy protection and a standard mode available for general users.

In operation 230, the terminal 100 may verify or determine a contact list and information relevant to the contact list corresponding to the determined mode of the terminal 100. A contact list corresponding to the standard mode may include a standard contact list, and a contact list corresponding to the secret mode may include a secret contact list and the standard contact list.

In operation 240, the terminal 100 may set only the verified or determined contact list and the information relevant to the verified or determined contact list to be accessible. In the standard mode, the terminal 100 may set only the standard contact list and information relevant to the standard contact list to be accessible. In the secret mode, the terminal 100 may set the standard contact list, the information relevant to the standard contact list, the secret contact list, and information relevant to the secret contact list to be accessible.

The method of protecting privacy in the terminal 100 will be described in detail with reference to the drawings based on a case in which the user authentication corresponds to a lock screen unlock input.

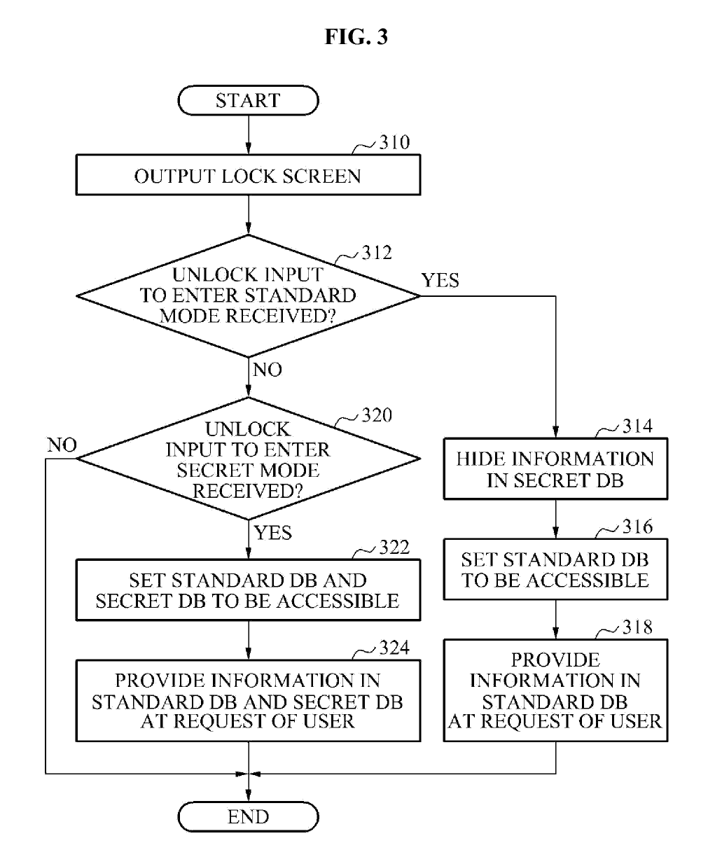

FIG. 3 is a flowchart illustrating a method of protecting privacy through an unlock input in the terminal of FIG. 1 according to an exemplary embodiment of the present invention.

Referring to FIG. 3, in operation 310, the terminal 100 may output a lock screen. In response to a reception of an unlock input, the terminal 100 may verify or determine whether the unlock input corresponds to an unlock input to enter a standard mode, in operation 312.

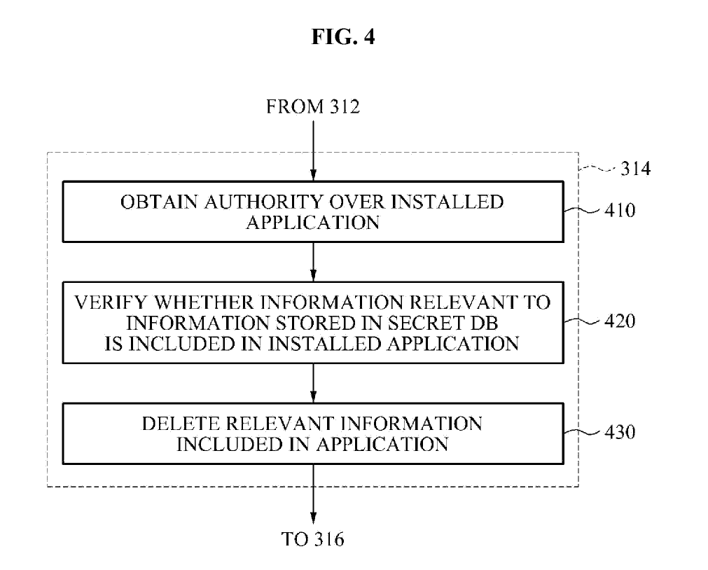

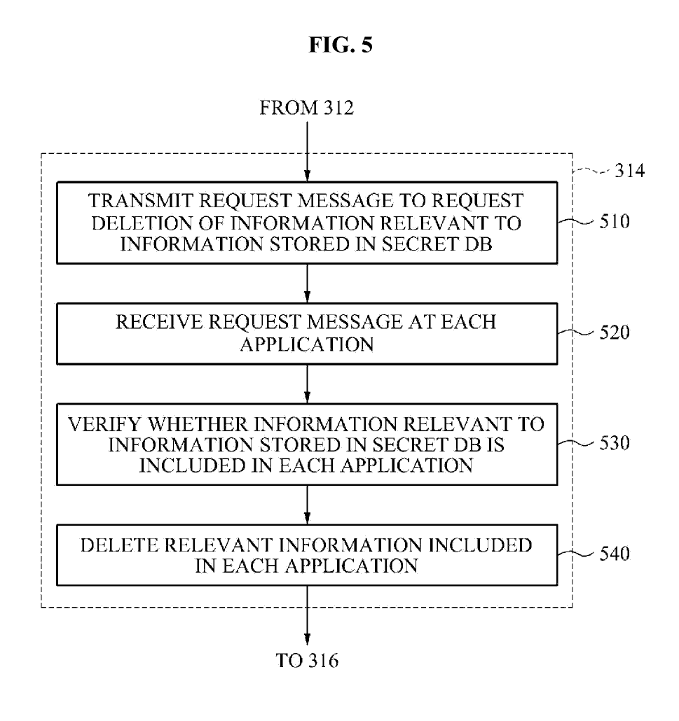

When it is verified or determined in operation 312 that the received unlock input corresponds to an unlock input to enter a standard mode, the terminal 100 may hide a secret contact list and information relevant to the secret contact list stored in the secret DB 150, in operation 314. Examples of operation 314 for hiding information may include operations of FIG. 4 or operations of FIG. 5.

In operation 316, the terminal 100 may set the standard DB 140 to be accessible and set the secret DB 150 to be inaccessible to the user, thereby enabling information included in the secret DB 150 not to be displayed on a screen of the terminal 100.

In operation 318, the terminal 100 may provide information of the standard DB 140 to the user at a request of the user.

When it is verified or determined in operation 312 that the received unlock input does not correspond to an unlock input to enter a standard mode, the terminal 100 may verify or determine whether the received unlock input corresponds to an unlock input to enter a secret mode, in operation 320.

When it is verified or determined in operation 320 that the received unlock input corresponds to an unlock input to enter a secret mode, the terminal 100 may set the standard DB 140 and the secret DB 150 to be accessible, in operation 322.

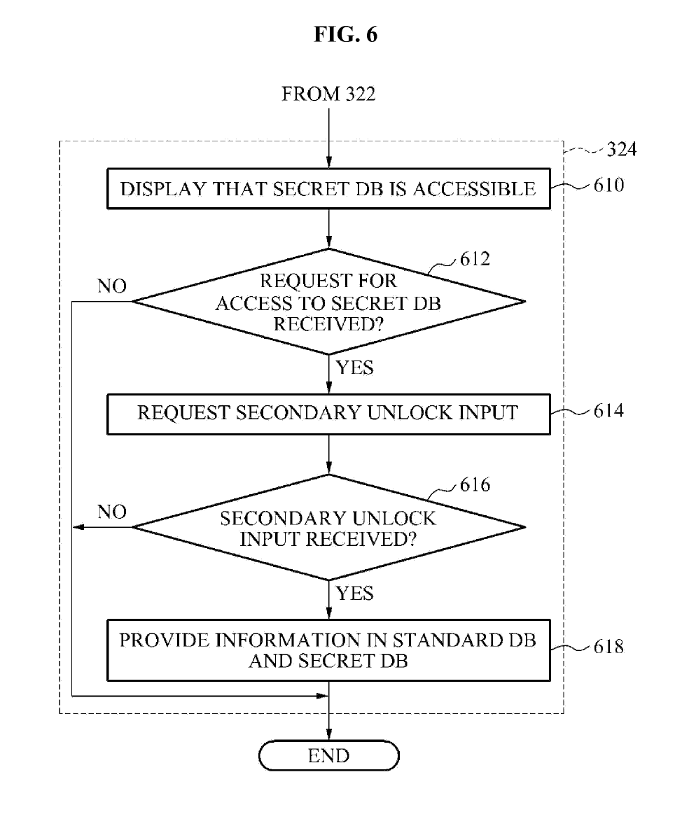

In operation 324, the terminal 100 may provide information in the standard DB 140 and information in the secret DB 150 to the user at a request of the user. In this example, the information in the secret DB 150 may be provided to the user through a double lock function. An example of providing the information in the secret DB 150 through the double lock function will be described in detail with reference to FIG. 6. If it is determined in operation 320 that the received unlock input does not correspond to an unlock input to enter a secret mode, the terminal 100 may not unlock the screen of the terminal 100.

FIG. 4 is a flowchart illustrating an example of hiding secret information in the terminal 100 of FIG. 1 according to an exemplary embodiment of the present invention.

Referring to FIG. 4, in operation 410, the terminal 100 may obtain an authority over an application installed on the terminal 100 to hide information stored in the secret DB 150 in the standard mode.

For example, an extracted identity, e.g., an extracted name, associated with a phone number classified as a secret contact may be used to search for applications and information of the application to be hidden. Rights may be obtained from each application to hide secret information of the application in a normal mode. More specifically, in a secret mode, when a certain item is classified as a secret item, information associated with the secret item may be determined in each application and the terminal 100 may obtain rights from each application to hide the information associated with the secret item to be hidden when the terminal 100 is in a normal mode. For example, a messenger application, a social network service (SNS) application, e.g., Facebook®, may hide secret information of the authorized user when the application is executed in a normal mode. Once an item is classified as a secret item, in a secret mode, the authorized user may distinguish information associated the secret item from information associated with a non-secret item if the terminal 100 indicates a symbol or other indicators to distinguish the information associated the secret item. Further, information associated with a secret item may include an image of a secret contact, text messages communicated with a secret contact, SMS messages, call logs, and the like. In a normal mode, a tagged image may be searched and hidden if the tagged image is associated with a secret contact, for example.

In operation 420, the terminal 100 may verify or determine whether information relevant to the information stored in the secret DB 150 is included in the installed application.

In operation 430, the terminal 100 may delete the relevant information included in the application not to be displayed in the application.

FIG. 5 is a flowchart illustrating another example of hiding secret information in the terminal 100 of FIG. 1 according to an exemplary embodiment of the present invention.

Referring to FIG. 5, in operation 510, the terminal 100 may transmit a request message to request deletion of information relevant to the information stored in the secret DB 150 to hide the information stored in the secret DB 150 in the standard mode.

In operation 520, each application installed on the terminal 100 may receive the request message. In operation 530, each application may verify or determine whether the information relevant to the information stored in the secret DB 150 is included in each corresponding application.

In operation 540, each application may delete the information related to the information stored in the secret DB 150 included in each corresponding application.

FIG. 6 is a flowchart illustrating a method of providing secret information through a double lock function in the terminal 100 of FIG. 1.

Referring to FIG. 6, in operation 610, the terminal 100 may display that the secret DB 150 is accessible by providing a secret contact view menu in response to a menu request of the user.

If a request for access to the secret DB 150 is received in operation 612, the terminal 100 may request a secondary unlock input from the user, in operation 614. The secondary unlock input may be identical to or different from an unlock input to enter a secret mode. The unlock input may be provided using one or more methods of recognizing a user, for example, pattern recognition, face recognition, fingerprint recognition, and a password.

If a secondary unlock input is received from the user in operation 616, the terminal 100 may provide information in the standard DB 140 and information in the secret DB 150 to the user at a request of the user, in operation 618.

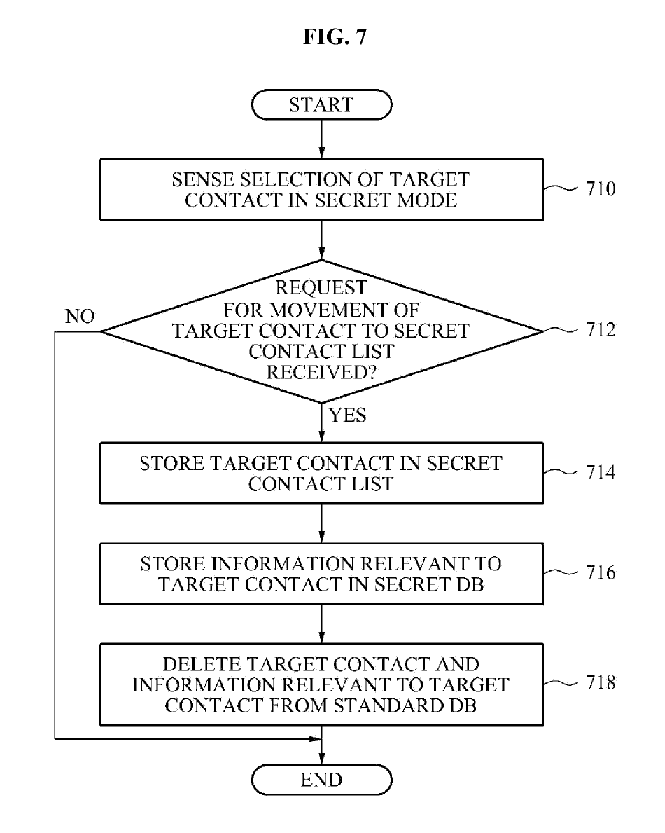

FIG. 7 is a flowchart illustrating a method of moving a contact included in a standard contact list to a secret contact list in the terminal 100 of FIG. 1 according to an exemplary embodiment of the present invention.

Referring to FIG. 7, in operation 710, the terminal 100 may sense a selection of a target contact included in a standard contact list in the secret mode. In operation 712, the terminal 100 may verify or determine whether a request for movement of the target contact to a secret contact list is received.

If it is verified or determined in operation 712 that a request for movement of the target contact to the secret contact list is received, the terminal 100 may store the target contact in the secret contact list, in operation 714. If it is verified or determined in operation 712 that a request for movement of the target contact to the secret contact list is not received, operations 714, 716, and 718 may not be performed.

In operation 716, the terminal 100 may store information relevant to the target contact in the secret DB 150.

In operation 718, the terminal 100 may delete the target contact and the information relevant to the target contact from the standard DB 140.

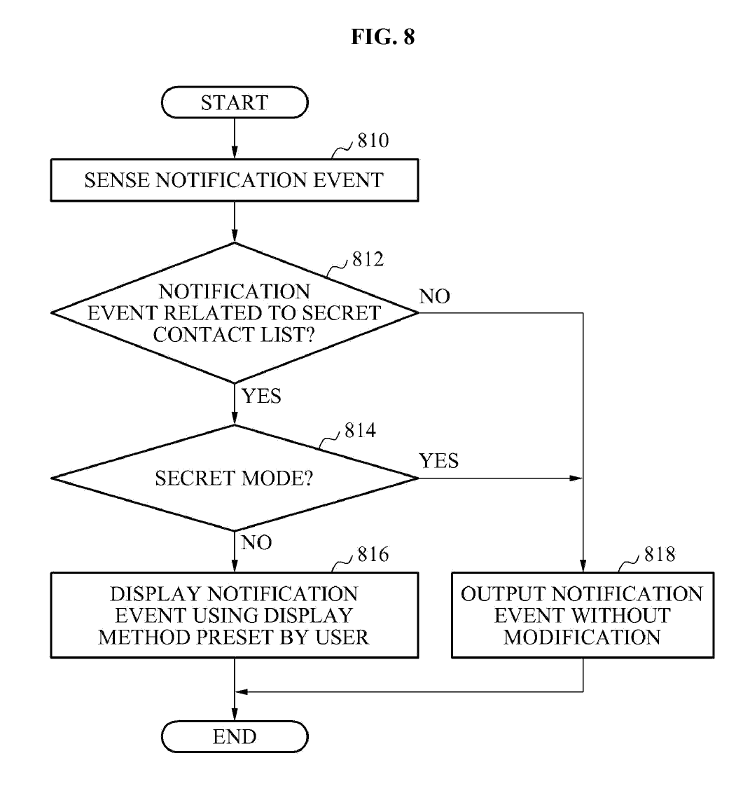

FIG. 8 is a flowchart illustrating a method of processing a notification event in the terminal 100 of FIG. 1 according to an exemplary embodiment of the present invention.

Referring to FIG. 8, in operation 810, the terminal 100 may sense a notification event. In operation 812, the terminal 100 may verify or determine whether the sensed notification event corresponds to a notification event related to a secret contact list. The notification event may include at least one of an incoming call, an incoming message, a missed call, and an application message.

If it is verified or determined in operation 812 that the sensed notification event corresponds to a notification event related to a secret contact list, the terminal 100 may verify or determine whether a current mode of the terminal 100 corresponds to a secret mode, in operation 814.

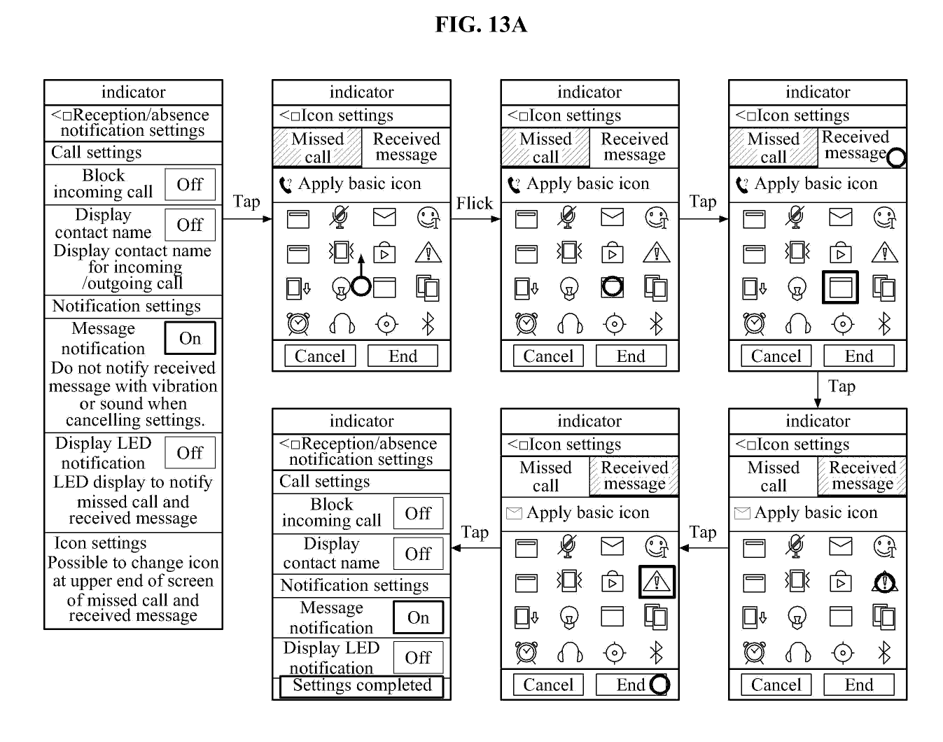

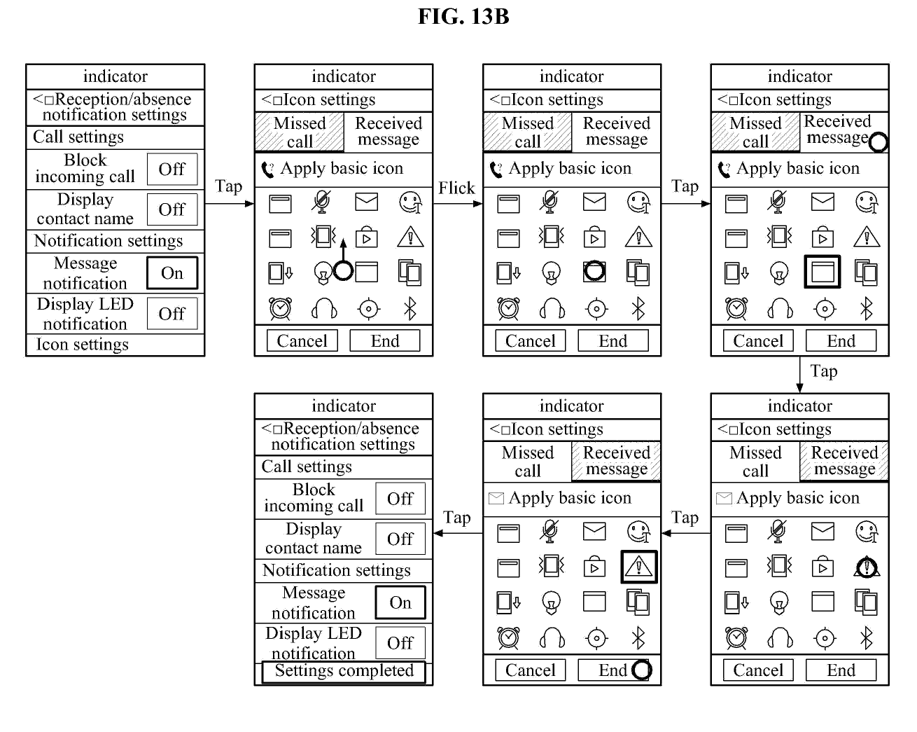

If it is verified or determined in operation 814 that the current mode of the terminal 100 does not correspond to a secret mode, the terminal 100 may display the notification event using a display method set by the user, in operation 816. For example, the notification may include a message reception event, a call reception event, and an appointment schedule event. If such events include information of a contact listed in a secret DB 150, one or more information fields may be removed or replaced in providing the notification events. Identity of the contact may be removed from the notification event or replaced by a symbol. For example, the name of the contact may be removed when displaying the notification event or replaced by a symbol, such as an icon (see e.g., FIG. 13A or FIG. 13B), a phone number, and the like. Further, a contact address, such as a phone number, an email address, and the like, may be removed or replaced by a symbol. According to other aspects, a symbol predetermined by an authorized user may be included in the notification event to indicate the notification event has been modified for normal mode. Thus, when the terminal is in normal mode, an authorized user may recognize that a notification from a contact classified as a secret contact while unauthorized users may not recognize the classification from the modified notification event. Other than a symbol, various settings, such as a predetermined shade, a predetermined color for an item in the modified notification event, may be used to indicate to the authorized user that the notification event is a modified one. For example, notification icons and/or text in the notification may have a color predetermined by an authorized user to indicate the notification event has been modified when displayed in a normal mode. With regard to messages, emails, and/or SNS messages from a contact classified in a secret DB 150, a predetermined phone number or a predetermined address may replace those of the contact classified in a secret DB 150. Text messages in the notification event may be replaced with a set of predetermined text messages so that the authorized user may recognize the notification event has been modified.

If it is verified or determined in operation 812 that the sensed notification event does not correspond to a notification event related to a secret contact list, or if it is verified or determined in operation 814 that the current mode of the terminal 100 corresponds to a secret mode, the terminal 100 may output the sensed notification event without modification, in operation 818.

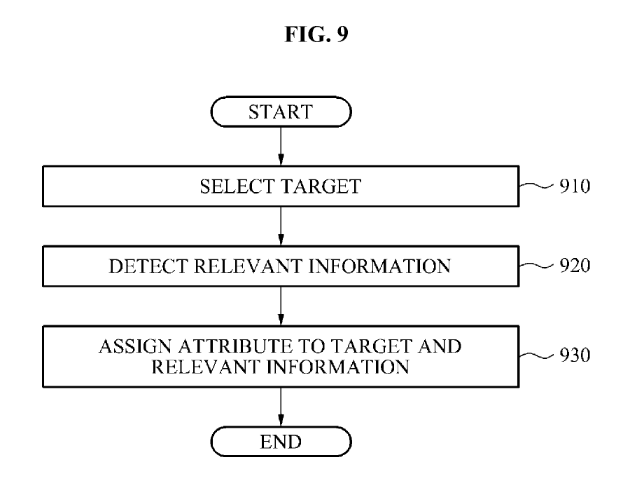

FIG. 9 is a flowchart illustrating a method of assigning an attribute in the terminal 100 of FIG. 1 according to an exemplary embodiment of the present invention.

Referring to FIG. 9, in operation 910, a target to which a predetermined attribute is to be assigned may be selected. In operation 920, the terminal 100 may detect relevant information related to the target stored in the terminal 100.

In operation 930, the terminal 100 may assign the attribute to the target and the detected relevant information. The assigned attribute may include one of deleting, hiding, and locking.

Hereinafter, an example of applying a method of protecting privacy in a terminal configured as described above according to an exemplary embodiment of the present invention will be described using output screenshots of a terminal.

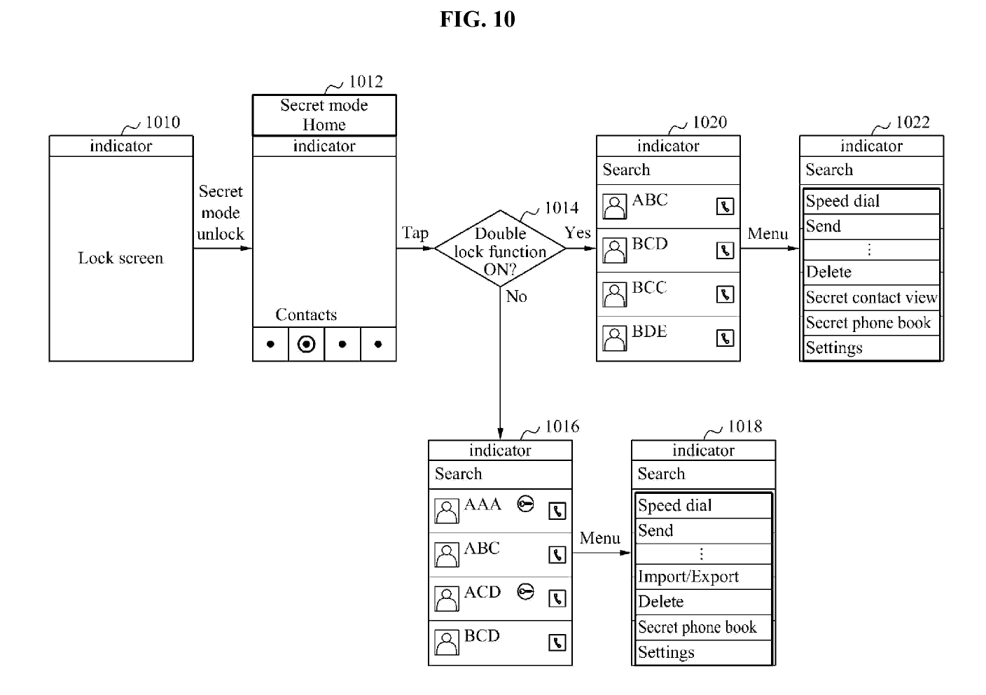

FIG. 10 illustrates an example of outputting a secret contact list based on double lock settings in the terminal 100 of FIG. 1 according to an exemplary embodiment of the present invention.

Referring to FIG. 10, in operation 1010, the terminal 100 may output a lock screen. In response to a reception of an unlock input to enter a secret mode, the terminal 100 may switch to a secret mode home screen, in operation 1012.

In response to sensing a selection of a phone book on the secret mode home screen, the terminal 100 may verify or determine whether a double lock function is set, in operation 1014.

If it is verified or determined in operation 1014 that the double-lock function is not set, the terminal 100 may output a list of all targets included in a standard contact list and a secret contact list. To distinguish targets included in the secret contact list, the terminal 100 may output the list of all the targets along with a separate indicator, for example, a key icon, in operation 1016. The indicator to distinguish the secret contact list may include an icon, for example, a key icon, color, and shade.

In response to sensing a menu output request, the terminal 100 may output a menu list including a “secret phone book” menu corresponding to a menu to output only a secret contact list, in operation 1018.

If it is verified or determined in operation 1014 that the double lock function is set, the terminal 100 may output targets included in the standard contact list without outputting targets in the secret contact list, in operation 1020.

In response to a reception of a menu output request, the terminal 100 may output a menu list including a “secret contact view” menu and a “secret phone book” menu, in operation 1022. The “secret contact view” menu may correspond to a menu to output the standard contact list and the secret contact list together, and the “secret phone book” menu may correspond to a menu to output only the secret contact list. If there is no registered secret contact list, the “secret contact view” menu may not be displayed in the menu list.

The terminal 100 may switch to the secret contact list or output the standard contact list and the secret contact list together in response to a user authentication input, for example, a fingerprint recognition, while outputting targets included in the standard contact list, although the “secret contact view” menu is not output and selected.

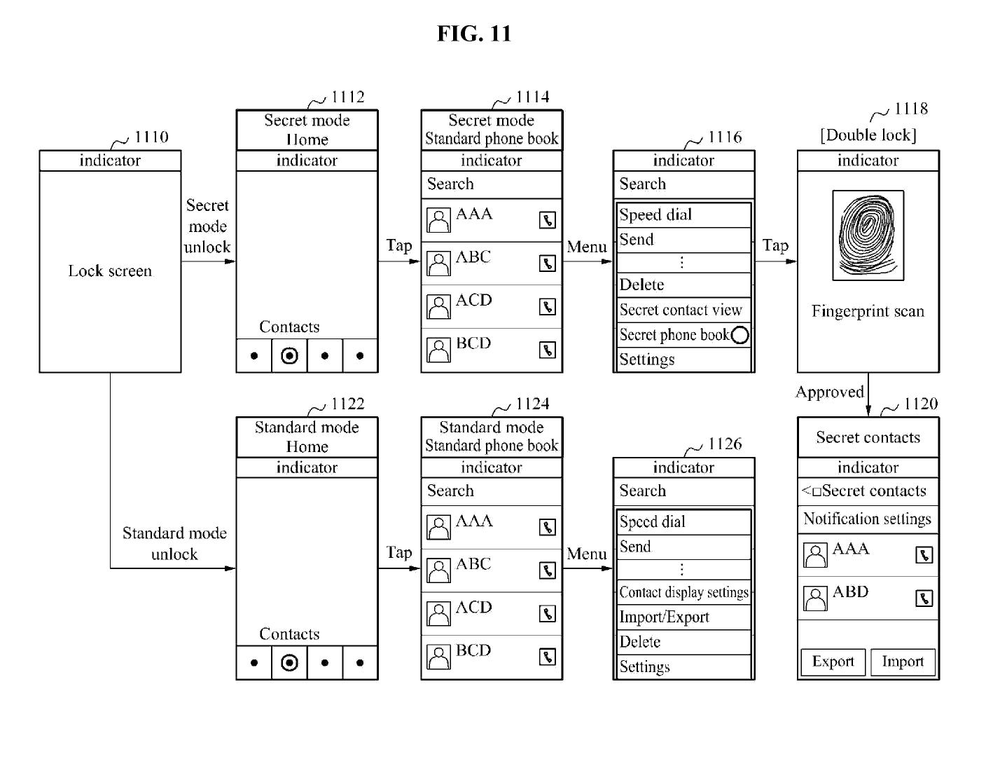

FIG. 11 illustrates an example of a menu output in a secret mode and a menu output in a standard mode in the terminal 100 of FIG. 1 according to an exemplary embodiment of the present invention.

Referring to FIG. 11, in operation 1110, the terminal 100 may output a lock screen. In response to a reception of an unlock input to enter a secret mode, the terminal 100 may output a secret mode home screen, in operation 1112.

In response to sensing a selection of a phone book on the secret mode home screen, the terminal 100 may output only a target included in the standard contact list, in operation 1114.

In response to a reception of a menu output request in the secret mode, the terminal 100 may output a menu list including a “secret contact view” menu and a “secret phone book” menu, in operation 1116. The “secret contact view” menu may correspond to a menu to output the standard contact list and the secret contact list together, and the “secret phone book” menu may correspond to a menu to output only the secret contact list.

If the “secret phone book” menu is selected in the menu list, the terminal 100 may request a fingerprint recognition for secondary unlock or authentication, in operation 1118.

When an appropriate fingerprint is recognized, the terminal 100 may output a list of targets included in the secret contact list, in operation 1120.

While outputting the lock screen in operation 1110, the terminal 100 may output a standard mode home screen in response to a reception of an unlock input to enter a standard mode, in operation 1122.

If a selection of a phone book icon is sensed on the standard mode home screen, the terminal 100 may output only a target included in the standard contact list, in operation 1124.

In response to a reception of a menu output request in the standard mode, the terminal 100 may output a menu list, in operation 1126. The menu list may not include a menu related to the secret contact list.

Unlike the menu list in operation 1116, the menu list in operation 1126 does not include the “secret contact view” menu and the “secret phone book” menu in the menu list in operation 1126.

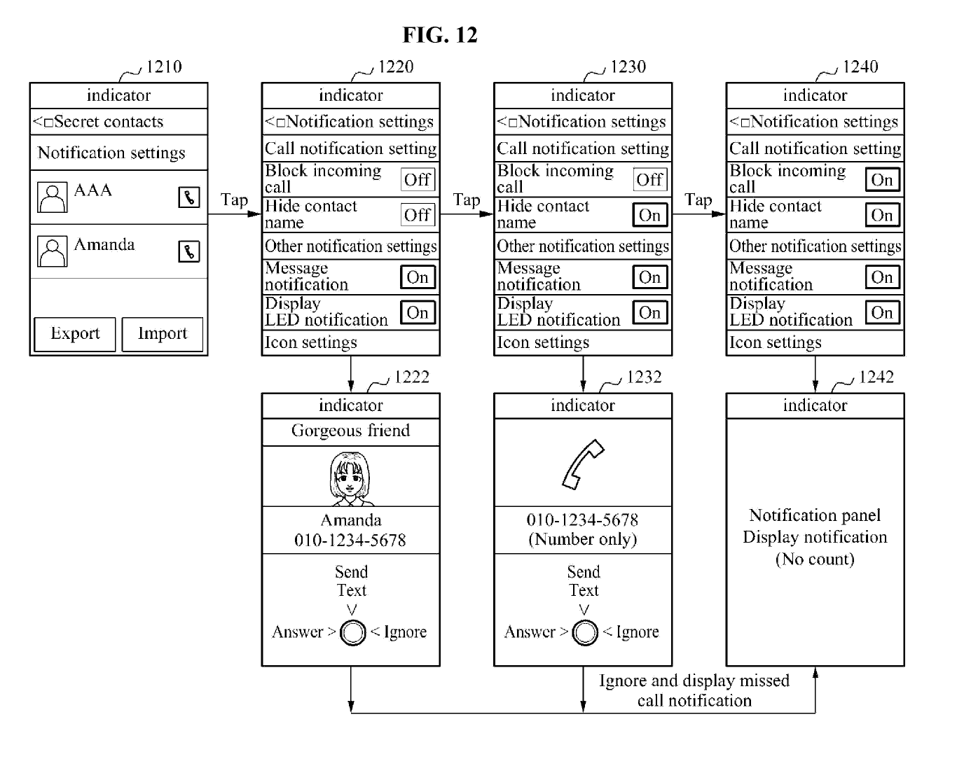

FIG. 12 illustrates an example of notification settings in the terminal 100 of FIG. 1 according to an exemplary embodiment of the present invention.

Referring to FIG. 12, in operation 1210, the terminal 100 may output a “notification settings” menu when outputting a secret contact list in a secret mode. The “notification settings” menu may correspond to a menu to set a notification method.

If the “notification settings” menu is selected in the secret mode, the terminal 100 may set the notification method, for example, whether an incoming call is to be blocked, whether a contact name is to be hidden, whether a message is to be notified, whether an LED notification is to be displayed, and icon settings.

As shown in operation 1220, a “block incoming call” menu may be off and a “hide contact name” menu may be off. In this example, when an incoming call from a target included in the secret contact list is received, the terminal 100 may display an incoming call notification similar to a reception of an incoming call from a target included in the standard contact list, in operation 1222.

As shown in operation 1230, the “block incoming call” menu may be off and the “hide contact name” menu may be on. In this example, when an incoming call from a target included in the secret contact list is received, the terminal 100 may display an incoming call notification emulating a reception of an incoming call from an unregistered target, in operation 1232.

As shown in operation 1240, the “block incoming call” menu may be on and the “hide contact name” menu may be on. In this example, when an incoming call from a target included in the secret contact list is received, the terminal 100 may not display an incoming call notification and immediately switch to a missed call notification, in operation 1242. The missed call notification may be displayed using a display method preset by the user. The preset display method may include, for example, a display method using an icon of a preset form. In addition, although a number of missed call notifications occur, a count of the missed call notifications may not be displayed.

If the user does not answer the incoming call in operations 1222 and 1232, the terminal 100 may display a home screen, as shown in operation 1242.

According to exemplary embodiments of the present invention, an effect of conveniently protecting privacy may be achieved by providing a secret mode and a standard mode, controlling a secret contact list and information relevant to the secret contact list not to be displayed on a screen of a terminal in the standard mode, and displaying a notification event related to a contact list stored in the secret contact list using a display method preset by a user in response to sensing the notification event.

FIG. 13A and FIG. 13B are diagrams illustrating examples of icon setting for secret mode according to exemplary embodiments of the present invention.

Referring to FIG. 13A and FIG. 13B, in a secret mode, a user may retrieve a setting mode and set certain icons, LED notifications, and the like. The user may select various methods to modify secret information, such as notifications and secret messages, to be displayed in a normal mode. For example, a determined icon may be displayed in a normal mode to indicate that secret information is received. An authorized user may access a secret mode to check original information after confirming the predetermined icon. The user may set a certain text message to replace an original secret message's text. In a normal mode, if a secret message is received, the preset text may be displayed instead of original text message of the received secret message. The user may select a provided text or may create a text to set the text message to be displayed in a normal mode instead of the original secret messages.

Multiple contacts may be added to or removed from a secret contact list individually or simultaneously. For example, in a secret mode, a contact list may be displayed with a selection option for each contact entry. An authorized user may select multiple contacts and add the selected entries to the secret contact list. Further, the authorized user may retrieve a secret contact list and may select multiple contacts and remove the selected entries from the secret contact list. Further, call history, message history, and the like may be displayed and multiple entries may be selected from the call history and/or message history to classify the selected entries to a secret item or a non-secret item.

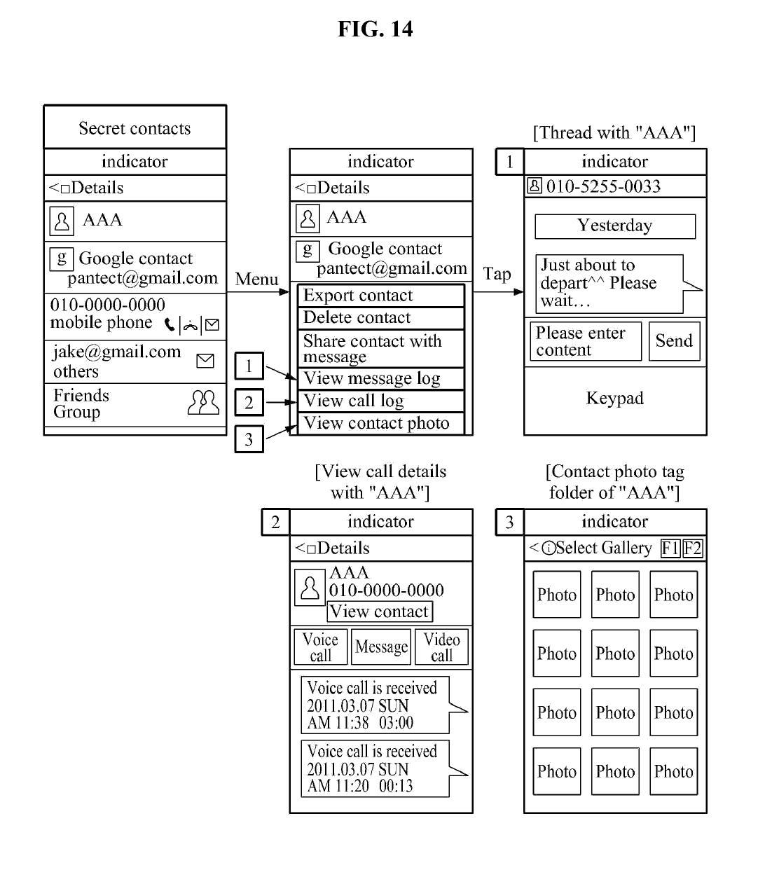

FIG. 14 is a diagram illustrating an example of accessing information associated with a secret item in an application according to an exemplary embodiment of the present invention.

Referring to FIG. 14, in a secret mode, when a secret item is displayed, a menu to retrieve information associated with the secret item may be provided. The information associated with the secret item may be separately accessed per each application or per each information type. For example, as shown in FIG. 14, when secret contact's information is displayed, a menu to access information associated with the secret contact may be displayed in response to an input. The menu may include a menu item to retrieve message communication log with the secret contact, a menu item to retrieve call history log with the secret contact, and a menu item to retrieve photo images of the secret contact. However, aspects are not limited thereto. In response to an input to select a menu item, a corresponding application may be executed to display the information associated with the secret contact. The retrieval may perform grouping of the information associated with the secret contact per each application and/or per each information type, such as photo, call log, message log, and the like.

The method of protecting privacy according to the exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as floptical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for providing a secret mode of a mobile terminal, the method comprising:
determining whether an input corresponds to an input to enter a secret mode; and
controlling, by a controller of the mobile terminal, a secret item to be output in the secret mode, the secret item being restricted in a non-secret mode.

2. The method of claim 1, wherein the secret item is stored in a secret database other than a standard database, and
wherein the secret database is configured to be accessible in the secret mode and inaccessible in the non-secret mode.

3. The method of claim 1, wherein if the input is a fingerprint input corresponding to an authorized user, the input is determined to be the input to enter the secret mode.

4. The method of claim 1, wherein the secret item comprises at least one of a name of a contact, an image of the contact, a call log associated with the contact, and a message associated with the contact.

5. The method of claim 1, further comprising:
displaying a lock screen on a display screen of a mobile terminal;
receiving the input to unlock the lock screen;
in the secret mode, displaying a list comprising a secret item and a non-secret item,
wherein a symbol is displayed in association with the secret item to indicate the status of the secret item.

6. The method of claim 5, wherein the secret item comprises a secret contact entry in a contact list or a text message communicated with a secret contact.

7. The method of claim 1, further comprising:
entering the non-secret mode;
in the non-secret mode, detecting a notification event associated with the secret item; and
in response to a determination that the notification event is associated with the secret item, modifying a notification output method of the detected notification event to hide secret information.

8. The method of claim 7, wherein the modifying of the notification output method comprises displaying a symbol indicating a notification event associated with the secret item.

9. The method of claim 1, further comprising:
in the non-secret mode, receiving a call from a secret contact, the secret contact being classified as a secret contact of an authorized user of the mobile terminal;
modifying a call display method by removing or changing information of the secret contact; and
displaying a call reception screen according to the modified call display method.

10. The method of claim 1, further comprising:
in the non-secret mode, executing an application comprising information associated with the secret item; and
modifying a display of the executed application by removing or changing the information associated with the secret item.

11. A mobile terminal to provide a secret mode, the mobile terminal comprising:
a processor to determine whether an input corresponds to an input to enter a secret mode, and control a secret item to be output in the secret mode, the secret item being restricted in a non-secret mode.

12. The mobile terminal of claim 11, wherein the secret item is stored in a secret database other than a standard database, and
wherein the secret database is configured to be accessible in the secret mode and inaccessible in the non-secret mode.

13. The mobile terminal of claim 11, wherein, if the input is a fingerprint input corresponding to an authorized user, the input is determined to be the input to enter the secret mode.

14. The mobile terminal of claim 11, wherein the secret item comprises at least one of a name of a contact, an image of the contact, a call log associated with the contact, and a message associated with the contact.

15. The mobile terminal of claim 11, further comprising:
a touch screen display to display a lock screen and to receive the input to unlock the lock screen,
wherein, in the secret mode, the touch screen display displays a list comprising a secret item and a non-secret item,
wherein a symbol is displayed in association with the secret item to indicate the status of the secret item.

16. The mobile terminal of claim 11, wherein, in the non-secret mode, the processor detects a notification event associated with the secret item, and
wherein in response to a determination that the notification event is associated with the secret item, the processor modifies a notification output method of the detected notification event to hide secret information.

17. The mobile terminal of claim 16, wherein the modification of the notification output method comprises a display of a symbol indicating a notification event associated the secret item.

18. The mobile terminal of claim 15, wherein, in the secret mode, the touch screen display displays a plurality of secret items,
wherein in response to a selection input, the processor retrieves information associated with the secret item and the touch screen display displays the retrieved information, the retrieved information being displayed in an executed application.

19. The mobile terminal of claim 18, wherein the retrieved information being displayed in an executed application comprises at least one of a text message communicated with a secret contact through a messenger application, a call history with a secret contact, and an image of a secret contact.

20. A mobile terminal to provide a secret mode, the mobile terminal comprising:
an interface to receive an input to select an item;
a display to display a plurality of items;
a processor to determine a selected item as a secret item, to obtain a right from an application associated with the secret item, and to retrieve information associated with the secret item from the application in a secret mode,
wherein the processor, in a non-secret mode, executes the application and modifies a display screen of the executed application to restrict the information associated with the secret item.
